(19) United States
(12) Patent Application Publication
(10) Pub. No.: US 2002/0161563 A1
(43) Pub. Date: Oct. 31, 2002

(54) System and method for performing vehicle interior configuration design

(76) Inventors: Naji Elabiad, Montreal (CA); Shawn W. Vick, Baie-D'Urfe (CA)

Correspondence Address: SMART & BIGGAR, Suite 3400, 1000 de la Gauchetiere Street West, Montreal, QC, H3B 4W5, CA

(21) Appl. No.: 10/096,249

(22) Filed: Mar. 13, 2002

Related U.S. Application Data
(60) Provisional application No. 60/275,040, filed on Mar. 13, 2001.

(51) Int. Cl. G06G 7/48

(52) U.S. Cl. 703/8

(57) ABSTRACT

A system for designing the interior configuration of a vehicle, where the vehicle is characterized by a vehicle type. The system includes a data storage unit storing a plurality of predetermined validation criteria. A processing unit is operative to generate an aircraft interior configuration design on a basis of the aircraft type. In response to design instructions received from the system user, the processing unit modifies the aircraft interior configuration design accordingly and performs a validation operation on each design instruction, at least in part on the basis of the contents of the data storage unit.

### FIELD OF THE INVENTION

The present invention relates to a system for configuring the interior of a vehicle. In particular, the system is characterized by the ability to generate, modify and validate the interior configuration design for a vehicle.

### BACKGROUND OF THE INVENTION

An important step in the process of manufacturing a vehicle is the design of the interior configuration for the vehicle. In most cases, such interior configuration design must be certified to meet predetermined safety standards and certification rules, while allowing the vehicle manufacturer and the customer to meet certain project targets,

Taking for example the design of the interior configuration of an aircraft, the interior configuration design must be certified to meet strict aircraft specific safety standards and certification rules, predetermined by a certification board within the aircraft industry. However, the design of the interior configuration of the aircraft is also typically constrained at the manufacturer end by important manufacturing, delivery, performance and financial targets. Further, the aircraft interior configuration design must also meet the customer needs such as preferences, performance, budget and time.

Traditionally, the first step in vehicle interior configuration design is the specification by a customer to the vehicle manufacturer of the requirements for the vehicle. Next, these requirements are directed to a design department of the manufacturer, responsible for preparing a suitable design on the basis of the customer requirements. The design is subsequently reviewed by a certification department, responsible for verifying that the design meets all of the requisite vehicle safety standards and certification rules. The design may also be reviewed by other departments to ensure that all important manufacturing, delivery, performance and financial targets are met. Typically, the design will be exchanged several times between the various departments prior to achieving validation of the design, potentially creating a bottleneck in the design process. Once the various departments have agreed upon a design, the proposed design is submitted to the customer for approval. If the customer requires any modifications or revisions to the design, the design is returned to the design department for amendment, and the design once again enters the multi-department loop for validation.

Thus, the traditional design process for the interior configuration of a vehicle is a lengthy one, involves several distinct stages and will typically require several iterations.

The background information provided above clearly indicates that there exists a need in the industry to provide an improved system and method for performing vehicle interior configuration design.

### SUMMARY OF THE INVENTION

In one aspect, the invention provides a system for designing the interior configuration of a vehicle, where the vehicle is characterized by a vehicle type. The system includes a data storage unit storing a plurality of predetermined validation criteria associated with the vehicle type, and a processing unit operative to generate a vehicle interior configuration design on a basis of the vehicle type. In response to design instructions received from the system user, the processing unit modifies the vehicle interior configuration design accordingly. The processing unit is operative to attempt to validate each design instruction received from the system user, at least in part on the basis of the contents of the data storage unit.

For the purpose of this specification, the term “configuration” in the expression “vehicle interior configuration” should be interpreted broadly to mean the selection and relative arrangement of parts, components or elements, such as furniture, fittings, cabinets, paint scheme, options, etc.

For the purpose of this specification, the term “validation criteria” should be interpreted broadly to mean rules, standards and parameters that a vehicle interior configuration design must satisfy in order to be valid. These validation criteria may include safety standards and certification rules for the vehicle interior configuration, as well as performance, manufacturing, financial and delivery targets or constraints.

Advantageously, the system as defined above simplifies the design process for the interior configuration of a vehicle, as well as shortens the time frame required to complete the design. In use, the system also ensures that the requisite validation criteria are strictly met. In particular, the system combines the design and certification operations that were previously performed by numerous, distinct departments, such that certification and validation of a design of the vehicle interior configuration occurs simultaneously with the progression of the design. Thus, a design proposal that violates a particular vehicle certification rule is brought to the attention of the designer almost immediately following application of the proposal to the design. Similarly, a design proposal that renders the operation financially unprofitable to the vehicle manufacturer, or that will delay the manufacturing time such that the delivery target is not met, or that will hinder the performance of the vehicle, is also brought to the attention of the designer almost immediately following application of the proposal to the design.

In a specific, non-limiting example of implementation, the system is used to design the interior configuration of an aircraft. The system is software implemented and resides on a computing device, such as a workstation or a laptop, at which a system user can access and use the system. The data storage unit is implemented by a computer-readable database, where this database stores predetermined validation criteria. The validation criteria may include aircraft specifications and certification rules, as well as performance, manufacturing, finance and delivery targets, for a plurality of different aircraft types. Alternatively, the contents of the database, notably the validation criteria associated with each different aircraft type, may be customized for one or more different design projects.

Note that the database may be stored in the memory of the computing device, or may be implemented as a remote, stand-alone database connected to the computing device.

In particular, the processing unit includes a design unit and a validation unit. The design unit is operative to generate an aircraft interior configuration (AIC) design, on the basis of the aircraft type specified by the system user. The design unit includes a set of AIC models, each configuration model associated with a particular aircraft type and meeting all of the certification rules for the associated aircraft type. When a system user specifies an aircraft type to the system, the design unit selects the appropriate, AIC model and generates therewith an AIC design. In this non-limiting example of implementation, the AIC design is transmitted to the system user as a graphical image displayed to the system user via a monitor of the workstation. Alternatively, the AIC design could be in textual form, or in a textual/graphical combination form.

In this specific example, an “aircraft interior configuration model” is a description of a basic floorplan layout of the interior of an aircraft, including available service options. More specifically, the aircraft interior configuration model is a selection and arrangement of components of the aircraft interior, as well as a set of service options, where each service option may be linked to a component. Examples of the components of the aircraft interior include furniture (e.g. seats), cabinets (e.g. galleys, wardrobes, lavatories, credenzas), trim (e.g. material, woodwork), accessories, paint schemes and options, among other possibilities. Examples of the service options include warranty requirements, training requirements, interim aircraft lift requirements, trade-in requirements, payment terms and concessions, among other possibilities.

The system user may submit design instructions to the system through an interface. Such design instructions may include functional criteria for the aircraft, such as a number of passengers or a travel plan, as well as modifications to the design of the aircraft. Examples of these modification instructions include the displacement, removal or addition of furniture or cabinets, changes to the paint scheme, changes to the trim selection, as well as the addition of optional accessories and systems.

Under a specific example, the processing unit creates a mouse-compatible interface screen on the display of the workstation, where the AIC design is graphically displayed. The interface provides the system user with a plurality of tools for viewing, modifying, exporting and querying the AIC design. The system user uses a mouse to interact with the tools and the AIC design, in particular to submit design modification instructions, for example using the well-known drag and drop operations to add or remove components to or from the AIC design.

The validation unit is operative to attempt to validate each design instruction submitted by the system user, by consulting the database of validation criteria. Once the validation unit has validated a design instruction, the design unit is responsive to this validated design instruction to modify the AIC design accordingly.

The expression “attempt to validate” should be understood as implying that a design instruction may be either validated or deemed invalid by the validation unit. The validation operation performed by the validation unit in order to attempt to validate a design instruction may include an evaluation of the submitted design instruction alone or, alternatively, an evaluation of the entire design once modified by the submitted design instruction.

Thus, each time the system user effects a modification to the floorplan of the aircraft, the validation unit determines whether or not the AIC design as modified continues to meet all of the predetermined validation criteria for the particular aircraft, such that safety standards, certification rules and project targets are not violated. When the validation unit determines that a particular design modification instruction is invalid (i.e. results in a violation of one or more validation criteria), the validation unit advises the system user of this invalidity.

In a specific example, the validation unit generates a violation message for transmission to the system user, including an indication of the particular design modification instruction that is invalid. In this specific example, the violation message is graphically displayed to the system user on the display of the workstation by outlining the area of the AIC design that is in violation of the validation criteria. It should be noted however that many different possibilities exist for advising the system user of the invalidity of a design instruction, and may be implemented by the validation unit 22.

In a variant, the system includes a configurator unit, which is operative to provide assistance to the system user for designing the aircraft interior configuration. In operation, the configurator unit generates a simple, step-by-step interface that is displayed on the screen of the workstation, and that asks questions to the system user concerning the AIC to be designed. Based on the answers provided by the system user, the configurator unit generates and builds the AIC design floorplan.

In another variant, the system for designing the interior configuration of an aircraft is operative to evaluate different performance targets, including weight measurement and, range measurement, in response to each design instruction received from the system user, at least in part on the basis of the contents of the data storage unit. For the purposes of this specification, the term “range” in the expression “aircraft configuration range measurement” implies the maximum distance an aircraft can travel without refueling.

In yet another variant, the system for designing the interior configuration of an aircraft is operative to computer different financial targets, such as a design cost or a net financial yield, in response to each design instruction received from the system user, at least in part on the basis of the contents of the data storage unit.

In yet another variant, the system for designing the interior configuration of an aircraft is operative to compute different delivery targets, such as a delivery schedule, in response to each design instruction received from the system user, at least in part on the basis of the contents of the data storage unit.

In a further aspect, the invention provides a vehicle configurator device for configuring the interior of a vehicle, where the vehicle is characterized by a vehicle type and the vehicle configurator device is in data communication with a database storing a plurality of predetermined validation criteria. The vehicle configurator device includes a design unit and a validation unit, and receives from a system user design instructions. The design unit is operative to generate a vehicle interior configuration design on the basis of the vehicle type, and is responsive to design instructions received from the system user to modify the vehicle interior configuration design accordingly. The validation unit is operative to attempt to validate each design instruction received from the system user, at least in part on the basis of the contents of the database.

In another aspect, the invention provides a system for designing the interior configuration of a vehicle, where the vehicle is characterized by a vehicle type. The system includes a data storage unit storing a plurality of predetermined validation criteria associated with the vehicle type, and a processing unit operative to generate a vehicle interior configuration design on a basis of the vehicle type. The processing unit is operative to attempt to validate each design instruction received from the system user, at least in part on the basis of the contents of the data storage unit, and to modify the vehicle interior configuration design in response to validated design instructions.

In yet another aspect, the invention provides a machine readable storage medium containing program instructions for execution on a computing device to implement a system for designing the interior configuration of a vehicle.

In yet another aspect, the invention provides a method for designing the interior configuration of a vehicle.

### BRIEF DESCRIPTION OF THE DRAWINGS

FIG. 1 is a functional block diagram of a system for designing the interior configuration of an aircraft, in accordance with an example of implementation of the present invention;

FIG. 2 illustrates an example of an aircraft interior configuration design, in accordance with the present invention; and

FIG. 3 is a functional block diagram of a system for designing the interior configuration of an aircraft, in accordance with an alternative example of implementation of the present invention; and

FIG. 4 is a block diagram of a computing device forming a suitable platform for the software implementation of the system for designing the interior configuration of an aircraft, in accordance with the present invention.

### DETAILED DESCRIPTION

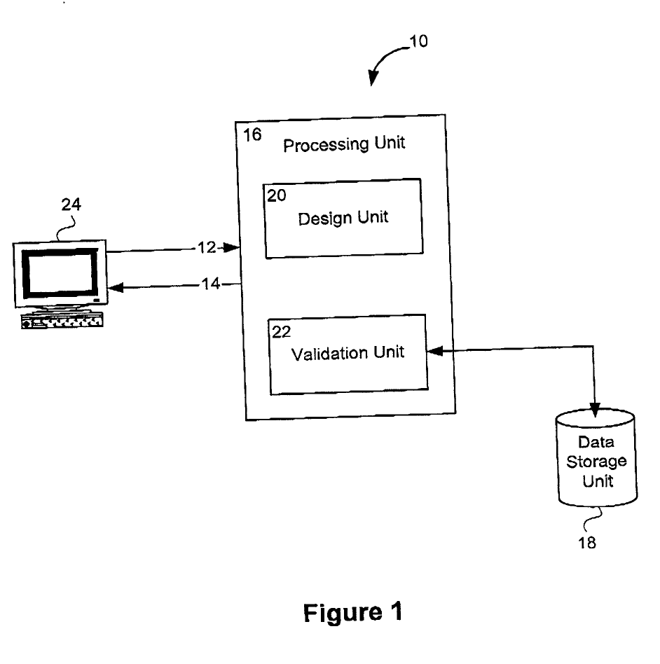

FIG. 1 illustrates a functional block diagram of a system for designing the interior configuration of a vehicle, in accordance with a non-limiting example of implementation of the invention. Specific to the example of implementation shown in FIG. 1, the vehicle is an aircraft. It should be noted however that the system described herein is not limited to the field of aircraft interior configuration design, and may be used to design the interior configuration of various different types of vehicles.

The system identified by the reference numeral 10 includes an input 12, an output 14, a processing unit 16 and a data storage unit 18. The input 12 and the output 14 permit the system 10 to exchange data signals with a system user at workstation 24. The system user initiates the design process by specifying to the system 10 a vehicle type, in this example an aircraft type, based on which an interior configuration design is to be generated by the system 10. The data storage unit 18 is implemented by a computer-readable database, and stores a plurality of predetermined validation criteria for a variety of different aircraft types. Alternatively, the contents of the database, including the validation criteria, could be customized for one or more different aircraft types and/or design projects.

In a specific example, the validation criteria stored by the database 18 includes predetermined safety standards and certification rules for each different aircraft type, established by a certification board within the aircraft industry. Examples of such certification rules include minimum aisle clearance, minimum Head Impact Criteria (HIC) clearance, emergency exit clearance and minimum door opening, among many other possibilities. The validation criteria also include predetermined design project targets, such as performance, delivery, finance and manufacturing targets, associated with different aircraft types. Examples of project targets include aircraft range, aircraft weight, delivery schedule, design Cost, net financial yield and design component modularity, among many other possibilities.

The processing unit includes a design unit 20 and a validation unit 22. The basic task of the design unit 20 is to generate aircraft interior configuration (AIC) designs, on the basis of the aircraft type specified by the system user. The basic task of the validation unit 22 is to attempt to validate design instructions received from the system user, on the basis of the contents of the database 18, as will be described in further detail below.

The processing unit 16 also includes an interface unit (not shown in FIG. 1) that permits interaction between the system 10 and the system user at workstation 24. Under this specific example of implementation, the interface unit creates Graphical User Interfaces (GUIs), in the form of data display screens, on the monitor of the workstation 24. In this specific example, a data display screen is a mouse-compatible screen that includes a plurality of tools by which the system user can view, modify, export and query an image, such as an AIC design, displayed on the screen. The system user uses a mouse to interact with the tools and the data display screen. Since the functionality and operation of such an interface unit is well known to those skilled in the art, it will not be described in further detail.

In order to initiate the design process, the system user must specify an aircraft type to the system 10. In this specific example of implementation, the system user sends to the system 10 via input 12 an input signal conveying the aircraft type. Alternatively, the processing unit 16 may generate a selection menu from which the user must select an aircraft type, where this selection menu is displayed to the user via a data display screen on the monitor of workstation 24. In another variant, assuming that the processing unit 16 of the system 10 is implemented in software, the system 10 may include different software versions for each different type of aircraft, where the system user specifies the aircraft type by selecting a specific software version to run.

The design unit 20 includes a set of AIC models, each configuration model associated with a particular aircraft type and meeting all of the validation criteria for the associated aircraft type. An AIC model is a description of a basic floorplan layout (also referred to as a spatial arrangement) of the interior of an aircraft, including a selection and arrangement of components of the aircraft interior as well as a description of various service options. The service options may be linked to different components of the aircraft interior. Examples of these components include furniture (e.g. seats), cabinets (e.g. galleys, wardrobes, lavatories, credenzas), trim (e.g. material, woodwork), accessories, paint schemes and options, among other possibilities. Examples of the service options include warranty requirements, training requirements, interim aircraft lift requirements, trade-in requirements, payment terms, concessions, among other possibilities. On the basis of the aircraft type specified to the system 10 by the system user, the design unit 20 selects the appropriate AIC model and generates therewith an AIC design.

In a specific example, the set of AIC models of the design unit 20 comprise a set of drawings formed of modules, where a particular AIC drawing includes defined relationships between the modules of the particular drawing as well as between the particular drawing and other, associated drawings. A module represents either a component of the AIC drawing or a service option, where the service option may be linked to a component of the AIC drawing. In the case of a component of the AIC drawing, the module may represent a piece of furniture, a cabinet, a trim, an accessory, or the like. In the case of a service option, the module may represent a warranty or training requirement, payment terms or concessions, among other possibilities.

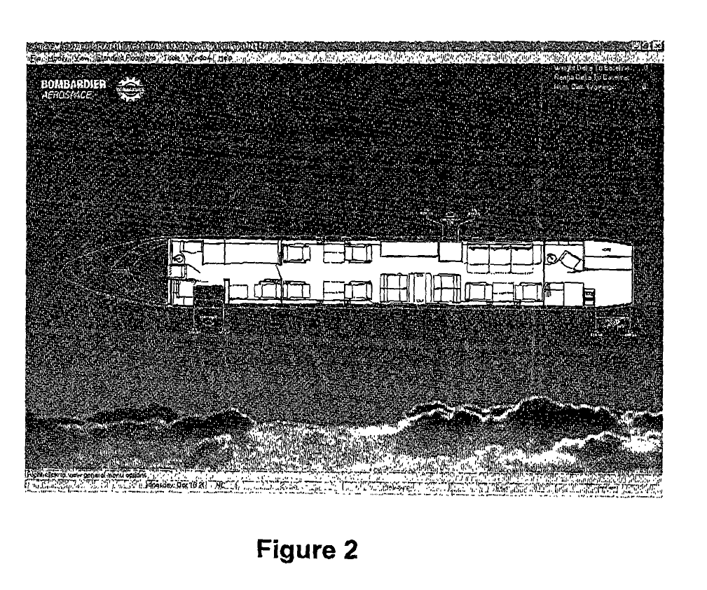

Under this non-limiting example of implementation, the AIC design generated by the design unit 20 is transmitted to the system user, in the form of a graphical image or drawing displayed to the system user on the monitor of the workstation 24, an example of which is shown in FIG. 2. Alternatively, the AIC design could be in textual form, or in a textual/graphical combination form.

The above-described interface unit of the processing unit 16 permits the system user to submit design instructions to the processing unit 16. Such design instructions may include functional criteria for the aircraft, such as a number of passengers or a travel plan, as well as modifications to the design of the aircraft. Examples of these modification instructions include the displacement, removal or addition of furniture or cabinets, changes to the paint scheme, changes to the trim selection, the selection of service options, as well as the addition of optional accessories and systems.

The design unit 20 is responsive to the design instructions received from the system user to modify the AIC design. In a specific example, a system user may graphically modify the AIC design displayed on the monitor of the workstation 24, using a mouse, where this graphical modification is translated by the interface unit of the processing unit 16 into a design instruction. An example of such a graphical modification would be using the well-known drag and drop operations to add or remove a component to or from the AIC design, where the interface unit provides to the system user, via the data display screen, lists of modules or components, both of standard and optional type, which may be added to the displayed AIC design.

For each design instruction submitted by the system user, the validation unit 22 consults the database of validation criteria 18 in an attempt to validate the design instruction. The expression “attempt to validate” is used since a design instruction may be either validated or invalidated by the validation unit 22, in dependence on whether or not the design instruction satisfies the associated validation criteria stored in database 18.

The validation operation performed by the validation unit 22 in order to attempt to validate a design instruction may include an evaluation of the submitted design instruction alone or, alternatively, an evaluation of the entire AIC design once modified by the submitted design instruction. Under this non-limiting example of implementation, the design unit 20 is almost immediately responsive to all design instructions submitted by the system user to modify the AIC design, without waiting for validation by the validation unit 22. The validation unit 22 performs its validation operation, whether on the design instruction alone or on the entire AIC design as modified, after the AIC design has already been modified by the design unit 20. Alternatively, the design unit 20 is only responsive to validated design instructions, and the validation operation by the validation unit 22 is performed prior to any operation by the design unit 20 upon submission of a design instruction by the system user.

Note that the original AIC design generated by the design unit 20 on the basis of the specified aircraft type is typically pre-validated by the validation unit 22. Alternatively, this pre-validation step is omitted, such that the original AIC design is only validated following receipt of the first design instruction from the system user.

Thus, the validation unit 22 is responsible for ensuring that, given modifications by the system user to the original AIC design generated by the design unit 20, the modified AIC design continues to meet the safety standards associated with the particular aircraft type and does not violate any predetermined certification rules or project targets. When the validation unit 22 determines that a particular design instruction is invalid (i.e. results in a violation of one or more validation criteria), the validation unit 22 is operative to advise the system user of this invalidity.

In a specific example, when the validation unit 22 determines that a particular design instruction is invalid, the validation unit generates a Violation Message for transmission to the system user, including an indication of the particular design instruction that is invalid. Under this specific example of implementation, the Violation Message is graphically displayed to the system user on the display of the workstation 24 by outlining the area of the AIC design that is in violation of one or more certification rules.

Note that one example of an invalid design instruction would be where the system user has added to the AIC design an extra seat for each row of seats in the main cabin area, thus reducing the aisle clearance space in the main cabin area to a value that is below the minimum aisle clearance required for certification. In such a case, the Violation Message could be displayed graphically on the AIC design as a colored box bounding the violation region that is defined by the added seats.

In addition to an indication of the design instruction that is invalid, the Violation Message may include additional information detailing the violation, such as the name of the modules or components involved in the violation, a description of the certification rule that has been violated and the specific coordinates of the violation region. Continuing with the above example of displaying the Violation Message to the system user as a colored box bounding the violation region on the AIC design, when the system user right clicks with the mouse on the violation region, a drop-down menu appears including the title of the violated certification rule and a menu option to open and view details of the violation. If the menu option is selected by the system user, a violation detail form appears on the data display screen containing the additional information detailing the violation.

Alternatively, the system user may be advised of the invalidity of a design instruction by the refusal of the design unit 20 to modify the AIC design as proposed by the system user. For example, in the case of a drag and drop operation by mouse, the design unit 20 would immediately undo the drag and drop operation and return the AIC design to its pre-modified layout, thus advising the system user that this design instruction is invalid. Note that many variant implementations exist for advising the system user of the invalidity of a design instruction, and are included within the scope of the present invention.

In a variant example of implementation, the processing unit 16 of the system 10 further includes a configurator unit, which is operative to provide assistance to the system user for designing the aircraft interior configuration. Operation by the configurator unit is initiated when the system user selects a Configurator Wizard menu item displayed on the screen of the workstation 24. In operation, the configurator unit generates a simple, step-by-step interface that is displayed on the screen of the workstation 24, and that asks questions to the system user concerning the AIC to be designed. Based on the answers provided by the system user, the configurator unit generates and builds a valid AIC design floorplan. In a specific example, when a new AIC design floorplan is being created, the system user is first prompted to enter details on the customer for the aircraft. Then, the system user is prompted to enter the modules for each zone of the aircraft from a pull-down menu. When all menus have been filled in, the configurator unit automatically generates a valid floorplan of the AIC design for display to the system user on the screen of the workstation 24.

Alternatively, the configurator unit could propose a valid AIC design based on functional criteria supplied by the system user in response to specific questions. These questions may include How many passengers?, What is the travel plan? (i.e. cities of origin and destination), How many in-flight meals to be served?, Do you need a conference room?, etc. For each question asked by the configurator unit, the system user could be provided with a drop-down menu containing a list of answers to choose from.

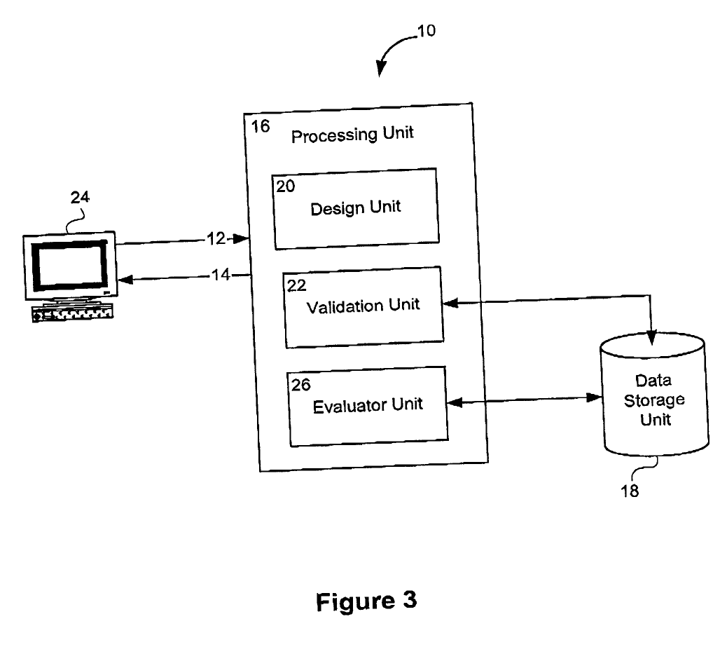

In another alternative example of implementation, the system 10 includes the design unit 20 as described above and an evaluator unit 26 as shown in FIG. 3. The evaluator unit 26 is operative to perform various measurement calculation operations associated with the AIC design, in response to each design instruction received from the system user, in order to evaluate performance/financial/manufacturing/delivery targets. In operation, in order to perform the measurement calculations the evaluator unit 26 consults the validation criteria stored in the database 18, which include aircraft specifications such as weight, balance and cost associated with different aircraft modules and different aircraft types.

The following measurement calculation operations may be performed by the evaluator unit 26, among many other possibilities:

1. Financial Net Yield

Subsequent to each modification made to the AIC design by the system user, for example the addition or removal of a piece of furniture, the evaluator unit 26 will calculate the financial net yield value of the transaction to the vehicle manufacturer. The evaluator unit 26 may also calculate the delta net yield between the modified AIC design and the vehicle manufacturer target net yield. Note that the evaluator unit 26 may also perform various other financial computations.

2. AIC Weight Measurement

Subsequent to each modification made to the AIC design by the system user, for example the addition or removal of a piece of furniture, the evaluator unit 26 will calculate the weight for the current AIC design, as modified. The evaluator unit 26 may also calculate a delta weight, specifically the weight differential between the modified AIC design and the original, baseline AIC design generated by the design unit 20.

3. AIC Range Measurement

Subsequent to each modification made to the AIC design by the system user, for example the addition or removal of a lavatory, the evaluator unit 26 will calculate the range for the current AIC design, where “range” is the maximum distance an aircraft can travel without refueling. This range measurement calculation is based on the weight of the current AIC design. The evaluator unit 26 may also calculate a delta range, specifically the range differential between the modified AIC design and the original, baseline AIC design generated by the design unit 20.

4. AIC Cost Measurement

Subsequent to each modification made to the AIC design by the system user, for example the addition or removal of a galley, the evaluator unit 26 will calculate the cost for the current AIC design, as modified. The evaluator unit 26 may also calculate a delta cost, specifically the cost differential between the modified AIC design and the original, baseline AIC design generated by the design unit 20.

5. Delivery Impact Management

Subsequent to each modification made to the AIC design by the system user, the evaluator unit 26 will compute an approximate delivery schedule for the current AIC design, as modified. The evaluator unit 26 may also calculate a delta timeframe, specifically the time differential between the delivery schedule for the modified AIC design and the delivery schedule for the original, baseline AIC design generated by the design unit 20.

Note that the evaluator unit 26 is capable to generate a Calculation Result Message for transmission to the system user at workstation 24. This Calculation Result Message may take the form of a textual message displayed on the data display screen, for example in the upper right hand corner of the screen as shown in FIG. 2. In a specific example, when the system user right clicks with the mouse on a particular measurement, a drop-down menu or a data form may appear presenting to the system user a breakdown of the measurement calculation. Taking for example the AIC range measurement, this calculation breakdown includes variables such as the number of passengers, a catering weight, a weight per passenger, etc. The system user may modify these variables, subsequent to which modification the evaluator unit 26 will re-calculate the range measurement accordingly.

In yet another alternative specific, non-limiting example of implementation, the system 10 provides to the system user a plurality of additional features for enhancing the design process, for example:

generating a 3-D virtual reality model of the AIC design;

generating an elevated view of the AIC design;

editing the floorplan of the AIC design;

selecting standard options and/or service bulletins;

printing;

configuring a cabinet;

selecting a trim and/or paint scheme;

zooming and panning;

dynamically setting and viewing the movement of a seat;

interfacing multiple AIC design documents;

extracting reports; and

keeping a summary log;

Accordingly, the processing unit 16 is operative to perform various functions, in addition to the validation and evaluator functions described above, for implementing the above features, as will be discussed below.

1. Generating a 3-D Virtual Reality Model of the AIC Design

This feature allows the system user to view and interact with a 3-D virtual reality model of the AIC design. The feature may be implemented using commercially available 3-D rendering software, such as CATIA® or RHINO® or, alternatively, the 3-D capacity could be integrated into the system software, using known programming languages

2. Generating an Elevated View of the AIC Design

This feature allows the system user to view the floorplan elevation of the AIC design, where the system user may select between a right-hand-side (RHS) elevation or a left-hand-side (LHS) elevation. When a RHS or LHS elevation view is requested, a separate form appears on the screen of the workstation 24 displaying the elevation view on the requested side. The elevation view ranges from the entrance area bulkhead of the aircraft to the baggage bay bulkhead of the aircraft, with a priority set on the main cabin area. In addition, this feature permits the system user to view the floorplan of the AIC design looking forward or looking aft from a given location. The system user is prompted to enter the coordinates of the location from which the view is to be generated.

3. Editing the Floorplan of the AIC Design

Editing functions are functions that allow the user to edit one or more modules of the floorplan of the AIC design. These functions include:

Copy Module

Move Module

Mirror Module

Delete Module

By launching any one of these functions, the system user is prompted to select which modules will be modified. In one example, the system user must use the mouse pointer to select the top left and bottom right corners of a bounding box that will entirely contain the selection. Once the selection is made, the following will occur, depending on the operation:

Copy

The system user is directed to select the starting and ending points of a vector that indicates the relative movement of the copied modules. After the vector is selected, only the modules that will not cause any interference problems and that have a grip point near the destination are copied over. If the vector crosses the centerline of the aircraft, the modules are mirrored from one side to the other side of the aircraft,

Move

This function is similar to the Copy function, except instead of copying the modules, the original ones are actually moved.

Mirror

This function copies and mirrors the selected modules from one side to the other side of the aircraft.

Delete

This function removes the selected modules from the AIC design floorplan.

4. Selecting Standard Options and/or Service Bulletins

This feature allows the system user to view all available options on a module, zone or system of the aircraft and to select the ones to retain. Further, the system user can view available service bulletins on all systems of the aircraft, and select the ones to retain. When the system user right clicks with the mouse on a particular module, zone or system, a drop-down menu appears from which an Options Selector form may be opened. Once launched, the Options Selector form appears on the screen, presenting to the system user all options available for the selected zone, module or system in a tree-view format. Similarly, the system user may click on a Service Bulletins menu item, such that a list of systems for which there exist one or more service bulletins appears. Once the system user has selected a system, a SB Selector form appears, displaying all service bulletins available for the selected system in a tree-view format. In this tree-view format, where an option or service bulletin has sub-options, the latter appear as branches of the parent option or service bulletin. Selecting an option, service bulletin or sub-option from a tree causes a separate form to open that contains a detailed description of the particular selection.

5. Printing

This function allows the system user to print any of the following data;

Floorplan

LHS/RHS Elevation View

Fwd/Aft Looking Views

Renderings

Cabinet Configurations

Selected properties and options

Zone/Module/System notes

Zone/Module/Option Descriptions

Drawings Tree Report

Weight and Balance Report

Cost Estimating Report

Specification Summary Report

A print function can be launched for each of the forms that contain data detailed above. When print function is launched, a form showing the printer to which data will be sent (for example, the default system printer), the paper size, the number of copies and a list of options as to which data to print is displayed, among other possibilities. The system user toggles on or off the optional data to print, selects the paper size and number of copies and prints the data by a PRINT button.

6. Configuring a Cabinet

This feature allows the system user to build the interior of cabinets, such as galleys, wardrobes, credenzas, etc., by dragging and dropping items from a list of modules onto the cabinet elevation view. Clicking with the mouse on a Configure CabinetName menu item in a module's drop-down menu opens a Cabinet Configurator form for that cabinet. Clicking anywhere on the cabinet's elevation view brings up a Cabinet Modules Selection form. Cabinet modules can be selected and dragged onto the cabinet's elevation view from the Modules Selection form, after which they can be moved around by drag and drop operations. The system user can increase or decrease the magnification size of the modules on the Modules Selection form by right-clicking on it and selecting an Enlarge or a Reduce sub-menu item. By clicking on one of the modules, a drag operation is initiated on the module, the Modules Selection form disappears and focus is given back to the Cabinet Configurator form. The user can also initiate a drag operation on a module already in the cabinet. The system user is prompted to enter a name for the cabinet configuration to recall or to create.

In a specific example, the Cabinet Configurator form has the menu groups and sub-items detailed below.

Files Menu

Load From File: Loads a configuration for active module from a file that was created using the Save To File menu item.

Save To File: Save the current configuration to a binary format file.

Clear Configuration: Clears the current configuration.

Export to ACAD: Exports the current configuration to AutoCAD.

Export to Excel: Exports the current configuration to Excel.

Print: Prints the current configuration.

Exit: Exit the Cabinet Configurator.

Edit Menu:

Undo: Undo last operation.

Redo: Redo last operation.

Copy: Copy modules.

Move: Move modules.

Delete: Delete modules.

View Menu

Zoom: Zoom to a window.

Pan: Initiate pan operation.

Zoom Previous: Recall last zoom window in the zoom queue.

Zoom All: Erase zoom queue.

Measure: Measure distance between two points.

7. Selecting a Trim and/or Paint Scheme

This function allows the user to select the material for each module or zone in the aircraft. A Trim Sketch Selector form is launched when the system user selects a Trim Sketch menu item from the module or zone's drop-down menu. The menu item is disabled for modules or zones that have no trim sketches to define. In a specific example, when the Trim Sketch Selector form opens, a generic isometric view of the zone or module is shown with numbered balloons at the location of each trim material to define. If the material has been selected, the balloon's background is green else it is yellow. Hovering over a balloon pops-up a tool tip text with the material that is selected for that item. By double clicking on a balloon, a pop-up input form appears on the screen and the system user can type-in the material name for that item. From the pop-up form, the system user can modify an existing selection, delete a selection or cancel changes.

The system user may also select one among a number of paint schemes to apply to the AIC design, and may select the color of the scheme's strips. The system user may select a Paint Scheme menu item, such that a Paint Scheme Selector form is launched. Once a paint scheme is selected by the system user from the Paint Scheme Selector form, a Paint Scheme Configurator form is launched, by which the system user can toggle the visibility of a strip on/off and select the color of a strip. A Paint Strip Color Selector form shows all the available standard color chips for paint strips.

8. Zooming and Panning

This feature allows the system user to zoom and to pan through the following views of the AIC design:

Basic Floorplan

Elevation View

Fwd/Aft View

Rendering View

Cabinet Configurator view

Paint Scheme Selector view

Zoom, zoom-out and pan functions can be initiated by the system user, either from a View menu group or by double-clicking on a ZOOM, ZOOM-OUT or PAN panel provided at the bottom of the screen.

ZOOM

In a specific example, when a ZOOM function is initiated, the system user is directed to click with the mouse pointer the top left and bottom right corners of the bounding box of the view window. When the top left corner is selected, a yellow box shows the limits of the zoom window as the mouse pointer hovers over the form. The box retains the same height/width ratio as the form.

PAN

When a PAN function is initiated, the user is asked to press down at the start point of panning and to release button at the end point of panning. Once the start point is selected, as the system user displaces the mouse pointer over the screen to select the panning end point, the entire view is dynamically panned.

ZOOM-OUT

When a ZOOM-OUT function is initiated, the previous pan or zoom window is displayed. The ZOOM-OUT queue is limitless and the system user can zoom back to the first, initial view.

ZOOM ALL

When a ZOOM ALL function is initiated, the zoom queue is cleared and the first, initial view is recalled.

9. Dynamically Setting and Viewing the Movement of a Seat

This feature allows the system user to recline the backrest, recline the leg-rest, swivel, track fwd/aft, track inboard/outboard each seat on the floorplan of the AIC design and to visualize its envelope after settings properties. By selecting a Module Properties Form in the drop-down menu of the module, the system user can change the values of recline, swivel and tracking settings. The system user can choose to select a “Show Module Contours In Elevation View” option and/or a “Show Modules Contours In Floorplan” option, such that the system user can view the modified contours of a seat in the floorplan and/or elevation views.

10. Interfacing Multiple AIC Design Documents

This function allows the system user to open more than one AIC design file at one time, and to flip from one file to the other. In a specific example, only one AIC design file may be shown on the screen at a time. The system user can open multiple files by selecting an Open menu item or a New menu item. To switch from one file to the other, the system user can view a Window menu group that contains a list of all opened files. Alternatively, multiple AIC design files could be shown at one time on the screen.

11. Extracting Reports

This feature permits the system user to extract reports on the active AIC design's, for example in MS®-Excel®. The function is launched when the system user selects a Create Report menu item, whereby the system user is prompted to enter a location for the report file to be created. At this point, the system user can cancel the operation or validate it. While the report is being generated, a progress bar indicates to the system user the percentage complete status.

12. Keeping a Summary Log

This function allows the system user to write down a log of usage of the system, for example when the system is used during meetings between at least one system user and other participants. The function is called when the system user selects a Meeting Log menu item, upon which a list of all meetings inscribed in the log is shown along with the date and a brief summary of the purpose of each meeting. The details of a previously created log can be viewed/modified by selecting it from the list. When a new log is being created, a Meeting Log Information form allows the system user to enter relevant information, such as:

List of attendees.

Date of meeting.

Location of meeting.

Summary of meeting.

Detailed description of meeting.

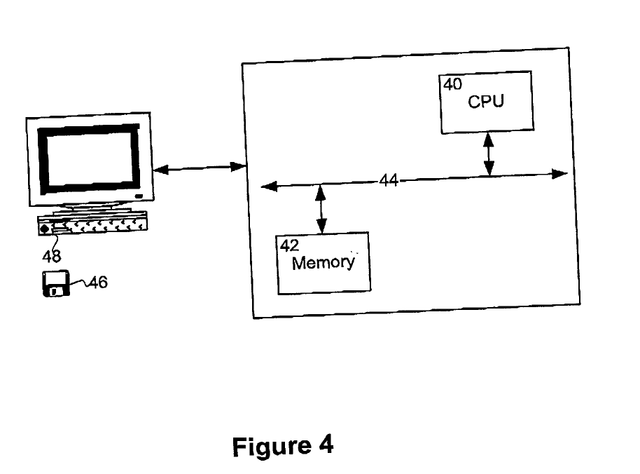

In the various examples of implementation described above, the processing unit 16 of the system 10 is software implemented on a computing platform, such as the workstation 24 or a laptop. The basic structure of the computing device constituting the workstation 24 is depicted in FIG. 4. The computing device has a Central Processing Unit (CPU) 40, a memory 42 and a bus 44 connecting the CPU 40 to the memory 42. The memory 42 holds program instructions for execution by the CPU 40 to implement the functionality of the system 10, specifically the various functions performed by the processing unit 16, for designing the interior configuration of an aircraft.

The memory 42 may also hold the above-described database 18, in particular in the case of a laptop, such that the system 10 is completely contained within the computing device. The system 10 may be stored on a computer readable medium 46, such as a floppy disk or a CD-ROM, that is external to the computing device. The computer readable medium 46 can be read by a drive 48, such as a floppy drive or a CD-ROM drive, to load the program instructions in the memory 42. The computer readable medium 46 may be part of a remote computing platform that is in some way connected to the computing platform that executes the program element for allowing the data transfer necessary to pass the program element to the computing platform on which the execution will take place. For example, a file server containing the program element that can be accessed over any suitable connection by another computing platform to obtain the program element is considered a computer readable medium storing the program element. Note that the database 18 may also be stored on a computer readable medium, such as a CD-ROM, that is external to the computing device.

It is intended for the present application to cover the modifications and variations of this invention provided that they come within the scope of the appended claims and their equivalents.

We claim:

1. A system for designing the interior configuration of a vehicle, the vehicle characterized by a vehicle type, said system comprising;
a) an input for receiving design instructions from a system user;
b) a data storage unit storing a plurality of predetermined validation criteria associated with the vehicle type;
c) a processing unit coupled to said data storage unit, said processing unit being operative to:
i) generate a vehicle interior configuration design on a basis of the vehicle type;
ii) modify said vehicle interior configuration design in response to design instructions received from the system user;
iii) attempt to validate each design instruction at least in part on the basis of the contents of said data storage unit.

2. A system as defined in claim 1, wherein said vehicle interior configuration design includes a spatial arrangement of a plurality of vehicle modules.

3. A system as defined in claim 2, wherein the vehicle is an aircraft, said vehicle interior configuration design being an aircraft interior configuration design, said vehicle modules being aircraft modules.

4. A system as defined in claim 3, wherein said plurality of aircraft modules are selected from the group consisting of furniture, cabinets, trim schemes, paint schemes, aircraft accessories, and service options.

5. A system as defined in claim 3, wherein said plurality of aircraft modules are selected from the group consisting of seats, galleys, wardrobes, lavatories, credenzas, material, woodwork, paint schemes, aircraft accessories, warranty requirements, training requirements, interim aircraft lift requirements, trade-in requirements, payment terms and concessions.

6. A system as defined in claim 3, wherein said processing unit includes a design unit for generating said aircraft interior configuration design, said design unit including a set of aircraft interior configuration models, each model being associated with a particular aircraft type.

7. A system as defined in claim 6, wherein said design unit consults said set of aircraft interior configuration models on the basis of the aircraft type for generating said aircraft interior configuration design.

8. A system as defined in claim 7, wherein said design unit is responsive to the design instructions received from the system user for modifying said aircraft interior configuration design.

9. A system as defined in claim 8, wherein said design instructions are selected from the group consisting of displacing an aircraft module, removing an aircraft module, adding an aircraft module, modifying an aircraft module.

10. A system as defined in claim 9, wherein said predetermined validation criteria include certification rules for a plurality of different aircraft types.

11. A system as defined in claim 10, wherein said predetermined validation criteria include safety standards for a plurality of different aircraft types.

12. A system as defined in claim 11, wherein said predetermined validation criteria include performance targets for a plurality of different aircraft types.

13. A system as defined in claim 11, wherein said predetermined validation criteria include financial targets for a plurality of different aircraft types.

14. A system as defined in claim 11, wherein said predetermined validation criteria include delivery targets for a plurality of different aircraft types.

15. A system as defined in claim 11, wherein said predetermined validation criteria include manufacturing targets for a plurality of different aircraft types.

16. A system as defined in claim 12, wherein said processing unit includes a validation unit for attempting to validate each design instruction submitted by the system user.

17. A system as defined in claim 16, wherein said validation unit consults the validation criteria stored in said database for attempting to validate a design instruction.

18. A system as defined in claim 17, wherein if a particular design instruction violates one or more of the validation criteria stored in said database, said validation unit determines that the particular design instruction is invalid.

19. A system as defined in claim 18, whereby if a particular design instruction is invalid said validation unit generates a violation message for transmission to the system user, the violation message including an indication of the particular design instruction that is invalid.

20. A system as defined in claim 12, wherein said processing unit includes an evaluator unit for evaluating a plurality of project targets in response to each design instruction received from the system user.

21. A system as defined in claim 20, wherein said evaluator unit is operative to perform measurement calculation operations.

22. A system as defined in claim 21, wherein said project targets are selected from the group consisting of performance targets, financial targets, delivery targets and manufacturing targets.

23. A system as defined in claim 22, wherein said measurement calculation operations are selected from the group consisting of aircraft weight measurements, aircraft range measurements, delivery schedule determination and financial value calculations.

24. A system as defined in claim 1, wherein said system receives at said input an input signal from the system user specifying the vehicle type.

25. A system as defined in claim 24, wherein said input signal conveys the vehicle type.

26. A system as defined in claim 1, wherein said processing unit is further operative to transmit said vehicle interior configuration design to the system user.

27. A system as defined in claim 26, wherein said vehicle interior configuration design is in a graphical form.

28. A system as defined in claim 26, wherein said vehicle interior configuration design is in a textual form.

29. A system as defined in claim 1, wherein said system is implemented in software on a computing platform.

30. A system as defined in claim 29, wherein the computing platform is a workstation.

31. A system as defined in claim 29, wherein the computing platform is a laptop.

32. A system as defined in claim 29, wherein the computing platform uses Pentium technology.

33. A system as defined in claim 1, wherein said data storage unit is a computer-readable database.

34. A machine readable storage medium containing program instructions for execution on a computing device to implement a system for designing the interior configuration of a vehicle, the vehicle characterized by a vehicle type, said system comprising:
a) an input for receiving design instructions from a system user;
b) a data storage unit storing a plurality of predetermined validation criteria associated with the vehicle type;
c) a processing unit coupled to said data storage unit, said processing unit being operative to:
i) generate a vehicle interior configuration design on a basis of the vehicle type;
ii) modify said vehicle interior configuration design in response to the design instructions received from the system user; and
iii) attempt to validate each design instruction received from the system user at least in part on the basis of the contents of said data storage unit.

35. A method for designing the interior configuration of a vehicle, the vehicle characterized by a vehicle type, said method comprising:
a) storing a plurality of predetermined validation criteria associated with the vehicle type;
b) receiving design instructions from a system user;
c) generating a vehicle interior configuration design on a basis of the vehicle type;
d) modifying the vehicle interior configuration design in response to the design instructions received from the system user;
e) attempting to validate each design instruction at least in part on the basis of the validation criteria.

36. A system for designing the interior configuration of a vehicle, the vehicle characterized by a vehicle type, said system comprising:
a) an input for receiving design instructions from a system user;
b) a data storage unit storing a plurality of predetermined validation criteria associated with the vehicle type;
c) a processing unit coupled to said data storage unit, said processing unit being operative to:
i) generate a vehicle interior configuration design on a basis of the vehicle type;
ii) attempt to validate each design instruction at least in part on the basis of the contents of said data storage unit;
iii) modify said vehicle interior configuration design in response to validated design instructions.

37. A vehicle configurator device for configuring the interior of a vehicle, the vehicle characterized by a vehicle type, said vehicle configurator device being in data communication with a database storing a plurality of predetermined validation criteria, said vehicle configurator device comprising:
a) an input for receiving design instructions from a system user;
b) a design unit coupled to said input, said design unit operative to generate a vehicle interior configuration design on the basis of the aircraft type, said design unit being responsive to design instructions received from the system user for modifying said vehicle interior configuration design;
c) a validation unit coupled to said design unit, said validation unit operative to attempt to validate each design instruction received from the system user at least in part on the basis of the contents of the database.

38. An aircraft configurator device for configuring the interior of an aircraft, the aircraft being characterized by an aircraft type, said aircraft configurator device in data communication with a database storing a plurality of predetermined aircraft specifications, said aircraft configurator device comprising:
a) an input for receiving design instructions from the system user;
b) a controller unit;
c) a memory in data communicative relationship with said controller unit;
d) a program element in said memory that is executed by said controller unit for:
i) generating an aircraft interior configuration design on the basis of the aircraft type;
ii) modifying said aircraft interior configuration design in response to the design instructions received from the system user;
iii) performing a validation operation on each design instruction at least in part on the basis of the contents of the data storage unit.
